(19) United States
(12) Patent Application Publication
(10) Pub. No.: US 2026/0054578 A1
(43) Pub. Date: Feb. 26, 2026

(54) SYSTEMS AND METHODS FOR CONTROLLING ELECTRIC VEHICLES BASED ON REAL-TIME TRAFFIC INFORMATION AND DRIVER CHARACTERISTICS

(71) Applicant: Mitsubishi Electric Research Laboratories, Inc., Cambridge, MA (US)

(72) Inventors: Yebin Wang, Cambridge, MA (US); Seho Park, Cambridge, MA (US); Hongtao Qiao, Cambridge, MA (US)

(73) Assignee: Mitsubishi Electric Research Laboratories, Inc., Cambridge, MA (US)

(21) Appl. No.: 18/810,107

(22) Filed: Aug. 20, 2024

(51) Int. Cl. B60L 15/20; B60H 1/00; B60L 1/00

(52) U.S. Cl. CPC B60L 15/20; B60H 1/00392; B60L 1/003; B60L 2240/14; B60L 2240/54; B60L 2240/62; B60L 2240/68

(57) ABSTRACT

A method for controlling an electric vehicle (EV) comprises obtaining a set of models corresponding to functional components, mobility components, and thermal components of the EV. Physical state data of the EV and a driver command input corresponding to a functional component is collected. The method further comprises generating driving cycle data for the EV, based on the physical state data and determining operating points of at least one mobility component, based on the driving cycle data. Each operating point of the plurality of operating points is parameterized by a desired torque and speed of the EV. The method further comprises generating a set of control commands for the functional component, based on the plurality of operating points, the set of models stored in the memory, and the driver command input and controlling the functional component, based on the set of control commands.

### TECHNICAL FIELD

The present disclosure relates generally to control of electrically operable vehicles, and more particularly to a system and a method for controlling one or more components of an electrically operable vehicle based on real-time traffic information and driver characteristics.

### BACKGROUND

Electrical vehicles (EV) are rapidly gaining popularity as a sustainable alternative to traditional gasoline-powered vehicles. These vehicles have constantly evolved to match their gasoline-powered counterparts in terms of the functionalities offered by them. For example, driven by the urge to improve operational efficiency and comfort, there has been a constant increase in the number of functionalities provided with electric vehicles over the years. Although executing each functionality comes with an increase in energy consumption within the vehicle, such functionalities have now become equal in importance with mobility functions. For example, for vehicles operating in hot and cold regions, providing heating ventilation and air-conditioning (HVAC) functionalities is equally important with providing mobility functionalities. However, since electric vehicles are powered by energy stored in batteries, it is essential to optimize energy consumption by various functionalities executed by the vehicle.

For any control system, the performance is heavily influenced by its disturbance (including reference). As such, for the optimization of battery-powered electric vehicle (BEV) efficiency, one critical disturbance is the driving cycles. Generally, representative driving cycles such as The United States Environmental Protection Agency's (US EPA) Urban Dynamometer Driving Schedule (UDDS) and US06 driving cycles have been adopted to evaluate the BEV design and control strategy. However, in several critical situations, these driving cycles do not accurately reflect real-world driving scenario including the information about trip, route, road traffic, as well as driver's characteristics. In fact, conventionally, driving cycle synthesis has been conducted using statistical features, which require experiment and data processing to deal with missed and noisy data. Additionally, such driving cycles describe velocity profiles from the macroscopic perspective such as traffic flow, without involving driver characteristics, and thus can compromise the feasibility and performance of the BEV.

### SUMMARY

Various example embodiments described herein are directed towards efficient BEV control strategies for optimizing performance of the BEV in view of real-time road conditions and driver characteristics. It is an objective of some example embodiments to provide techniques tailored for providing online control of one or more vehicular functions of the BEV, based on real-time traffic conditions and driver characteristics. Some embodiments utilize the real-time traffic conditions to infer road traffic situations in relation to which customized operational modes of various vehicular functions may be designed and executed. Some embodiments are directed towards synthesizing driving cycles for BEV control using microscopic traffic flow models. Such a manner of synthesis provides driving cycle data with driver characteristics defined at a highly granular level that is suitable for performing online control of vehicular functions.

Some embodiments are based on the realization that the suitability of a BEV control strategy in terms of consumer needs (for example, mileage or fuel economy) depends largely on who operates the vehicle and where the vehicle is operated. Accordingly, it is a recognition of some embodiments that a control strategy that is defined in reference to driver characteristics and real-time traffic conditions would better fit the requirements of the drivers/occupants of the vehicle. Motivated by such a realization, some embodiments synthesize driving cycle data that encodes traffic information and driver characteristics, effectively addressing where and by whom the electric vehicle is operated. Towards this end, some embodiments synthesize a driver-route-traffic-specific driving cycle which encodes traffic information and driver characteristics.

Some embodiments are also based on the realization that in a BEV, both propulsive (EV drivetrain) and HVAC subsystems consume most of the battery energy. Since the propulsive power consumption is fully governed by the driver, the vehicle power management system has negligible room to improve the fuel economy by adjusting the propulsive power demand. It is a realization of some embodiments that the coincidence or simultaneous occurrence of the peaks of propulsive power demands and HVAC power demands incurs extra battery losses and undesirable stress on battery thermal management system, potentially shortening the range and lifespan of battery. In fact, through experimentations, some embodiments realized that the HVAC peak may be delayed with respect to the propulsive power peak so that the propulsive power peak and the HVAC power peak are asynchronized in time, which is always possible given the large time constant of vehicle thermal dynamics. It is an objective of some embodiments to determine power control of HVAC system of a BEV to extend the range of the BEV and the lifespan of the battery, and enhance the safety of the BEV.

It is also an object of some embodiments to determine HVAC power control of the BEV while a driver is taking a trip from a current location to a target location. While the propulsive power demand is fully controlled by driver, it is the realization of some embodiments that it is beneficial to predict future propulsive power demand of the ongoing trip and shape the HVAC power demand accordingly. It is also the realization of this invention that the future propulsive power demand for the rest of the ongoing trip is largely characterized by a driving cycle and the terrain information of the route for a given BEV-velocity profile along the route of the trip. The driving cycle, although not exactly known, is strongly related to the real-time traffic information along the route and the driver characteristics. Thus, some embodiments are directed towards dynamically synthesizing the driver cycle. Furthermore, it is an object of some embodiments to incorporate route information of the rest of the ongoing trip, real-time traffic data, and driver characteristics to predict driver-route-traffic-specific driving cycle for the rest of the trip.

Some embodiments capture the driver characteristics by modeling a driver as a parametric velocity tracking controller which tries to track a given velocity reference. The velocity reference may be a route-traffic-specific driving cycle encoding the real-time traffic information. The parameters of the velocity tracking controller may be tuned to reflect different driver characteristics. Accordingly, in some embodiments, a method for synthesizing a driver-specific real-world driving cycle (also termed as driver-route-traffic-specific driving cycle) may be provided to reflect driver characteristics as well as road traffic situations for a specific trip.

Some embodiments also provide a method for generating an optimized HVAC control strategy for a BEV for improving power consumption. Some embodiments derive a reduced-order model of dynamics, losses, and constraints of a propulsive motor. The model is differentiable and thus allows efficient propulsive and HVAC commands optimization. In this regard, some embodiments conduct physics-based model reduction and data-driven modeling of motor, temperatures, and HVAC subsystem and determine the optimal HVAC control strategy online based on driver commands, reduced order models, and the driver-route-traffic-specific driving cycle for a particular trip.

In some embodiments, the dynamics of cabin air temperature, battery, and motor of the BEV can be modeled as three first-order ordinary differential equations, where the control variables are cooling air temperature, cooling air mass flow rate, coolant temperature and coolant mass flow rate. Accordingly, the HVAC power consumption model is represented as a function of the vehicle speed, the temperatures of ambient environment, battery, motor, and cabin air, and control variables of temperature dynamics of battery, motor, and cabin air.

In some embodiments, the dynamics of cabin air temperature, battery, and motor of the BEV can be modeled as three first-order ordinary differential equations, where the control variables are cooling air temperature, coolant temperature and coolant mass flow rate. Accordingly, the HVAC power consumption model is represented as a function of the vehicle speed, the temperatures of ambient environment, battery, motor, and cabin air, and control variables of temperature dynamics of battery, motor, and cabin air.

Additionally, the HVAC power consumption model is represented as a function of the vehicle speed, cooling air temperature entering the cabin of the vehicle, cabin air temperature, ambient temperature, battery temperature, motor temperature etc. For ease of reference, some embodiments may refer vehicle speed, cooling air temperature entering the cabin, cabin air temperature, ambient temperature, battery temperature, motor temperature, coolant temperature and coolant mass flow rate as the operating condition of the HVAC system. For a given HVAC subsystem and a specific operation condition, its optimal power consumption may be calculated by solving an optimization problem wherein the cost function is power consumption and the decision variables are speeds of compressor, radiator fan, cooling air fan and coolant pump, and the constraints represent the HVAC subsystem physics at steady-state. Given multiple pairs of data point where each pair comprises the optimal HVAC power consumption and the corresponding operation condition, function approximation may be performed to obtain the HVAC power consumption model through data fitting.

Accordingly, some embodiments provide a method for controlling the HVAC system of a BEV by determining an HVAC power command (defined in terms of operation points), based on a driver's propulsive command and HVAC command, reduced-order models of motor, temperatures, HVAC power consumption, as well as the driver-route-traffic-specific driving cycle. The HVAC power control trajectory/command may be determined by controlling the cooling air temperature, coolant temperature and coolant mass flow rate to minimize the total energy loss while finishing the drive cycle and maintaining the temperatures within certain bounds.

In order to realize the aforementioned objectives and advantages, various embodiments of this disclosure provide controllers, control methods and systems for controlling an HVAC subsystem of an electric vehicle in accordance with reduced order models for HVAC subsystem, temperature dynamics of cabin, battery and propulsive motor, and losses of the battery and the propulsive motor.

According to some embodiments, a controller for controlling an HVAC subsystem of a BEV is provided. The controller comprises a memory configured to store computer-executable instructions and a set of models corresponding to a plurality of functional components of the BEV, a plurality of mobility components of the BEV, and a plurality of thermal components of the BEV. The controller further comprises a processor configured to execute the instructions for controlling the HVAC subsystem. In this regard, the processor collects physical state data of the BEV and a driver command input corresponding to a functional component of the plurality of functional components of the BEV. Further, the processor generates driving cycle data for the BEV, based on the physical state data and determines a plurality of operating points of at least one mobility component of the plurality of mobility components of the BEV, based on the driving cycle data. Each operating point of the plurality of operating points is parameterized by a desired torque and speed of the BEV. Furthermore, the processor generates a set of control commands for the functional component, based on the plurality of operating points, the set of models stored in the memory, and the driver command input, and controls the functional component, based on the set of control commands.

According to some other embodiments, a computer-implemented method for controlling an HVAC subsystem of a BEV is provided. The method comprises obtaining a set of models corresponding to functional components, mobility components, and thermal components of the BEV. Physical state data of the BEV and a driver command input corresponding to a functional component is collected. The method further comprises generating driving cycle data for the BEV, based on the physical state data and determining operating points of at least one mobility component, based on the driving cycle data. Each operating point of the plurality of operating points is parameterized by a desired torque and speed of the BEV. The method further comprises generating a set of control commands for the functional component, based on the plurality of operating points, the set of models stored in the memory, and the driver command input and controlling the functional component, based on the set of control commands.

### BRIEF DESCRIPTION OF THE DRAWINGS

The presently disclosed embodiments will be further explained with reference to the following drawings. The drawings shown are not necessarily to scale, with emphasis instead generally being placed upon illustrating the principles of the presently disclosed embodiments.

FIG. 1A illustrates a block diagram of a controller for controlling a battery-powered electric vehicle (BEV), according to some embodiments;

FIG. 1B illustrates a method for controlling the BEV, according to some embodiments;

FIG. 1C illustrates a power control system for controlling a propulsive system and an HVAC system of the BEV, according to some embodiments;

FIG. 2 illustrates a method for generating control commands for the propulsive system and the HVAC system of the BEV, according to some embodiments;

FIG. 3A illustrates an exemplar method for synthesizing driver-route specific driving cycle, according to some embodiments;

FIG. 3B illustrates a method for identifying driver characteristic parameters, according to some embodiments;

FIG. 4 illustrates a method for generating propulsive command based on the driver-route-traffic-specific profile and a vehicle body model, according to some embodiments;

FIG. 5A illustrates schematics of propulsive motor modeling for the BEV, according to some embodiments;

FIG. 5B illustrates schematics of HVAC power consumption modeling for the BEV, according to some embodiments;

FIG. 5C illustrates schematics of battery modeling for the BEV, according to some embodiments;

FIG. 5D illustrates schematics of temperature dynamics modeling for the BEV, according to some embodiments;

FIG. 5E illustrates an equivalent electric circuit model for a battery cell utilized for battery modelling, according to some embodiments;

FIG. 6 illustrates a method for generating an HVAC command, according to some embodiments; and

FIG. 7 is a schematic illustrating a computing device for implementing various hardware components, according to some embodiments.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like-reference numbers and designations in the various drawings may indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

Over the past few years, battery powered electric vehicles (BEVs) have witnessed rapid transformation in terms of the number of secondary functionalities that they can execute apart from the primary functionality of mobility. Such an increase in the number of functionalities provided with these vehicles has been mainly due to the constant urge to improve operational efficiency and comfort of using electric vehicles. However, the increase in number of functionalities and in some cases, the increase in complexity of such functionalities, has led to increased power demand in the vehicles. Due to this, the need to optimize power supply and power utilization in BEVs has become more important. In a battery-powered electric vehicle (BEV or simply EV), both propulsive and HVAC subsystems consume most of the battery energy. While the propulsive power consumption is fully governed by driver and does not offer any room for the vehicle power management system to improve the fuel economy by adjusting the propulsive power demand. Accordingly, it is a realization that the coincidence of the peaks of propulsive and HVAC power demands incurs extra battery losses and undesirable stress on battery thermal management system, and potentially shortens the battery lifespan. In fact, the system can benefit from delaying the HVAC peak so that the propulsive power peak and the HVAC power peak are asynchronized in time, which is always possible given the large time constant of vehicle thermal dynamics. It is an objective of some embodiments to determine power control of HVAC subsystem of a BEV to extend the range of the BEV and the lifespan of the battery, and enhance the safety of the BEV.

It is also an object of some embodiments to determine HVAC power control of the BEV during an ongoing trip from a current location to a target location. While the propulsive power demand is fully controlled by a driver, it is the realization of some embodiments that it is beneficial to predict future propulsive power demand of the ongoing trip and shape the HVAC power demand accordingly. It is also the realization of some embodiments that the future propulsive power demand for the rest of the ongoing trip is largely characterized by a driving cycle and the terrain information of the route for a given BEV-velocity profile along the route of the trip. The driving cycle, although not exactly known, is strongly related to the real-time traffic information along the route and the driver characteristics. It is also an object of some embodiments to incorporate route information of the rest of the ongoing trip, real-time traffic data, and driver characteristics to predict driving cycle for the rest of the trip. It is also an object of some embodiments to determine HVAC power control of the BEV based on reduced order models for HVAC subsystem, temperature dynamics of cabin, battery and propulsive motor, and losses of battery and propulsive motor. Hereinafter, the terms BEV and EV would mean the same and are used interchangeably throughout this disclosure.

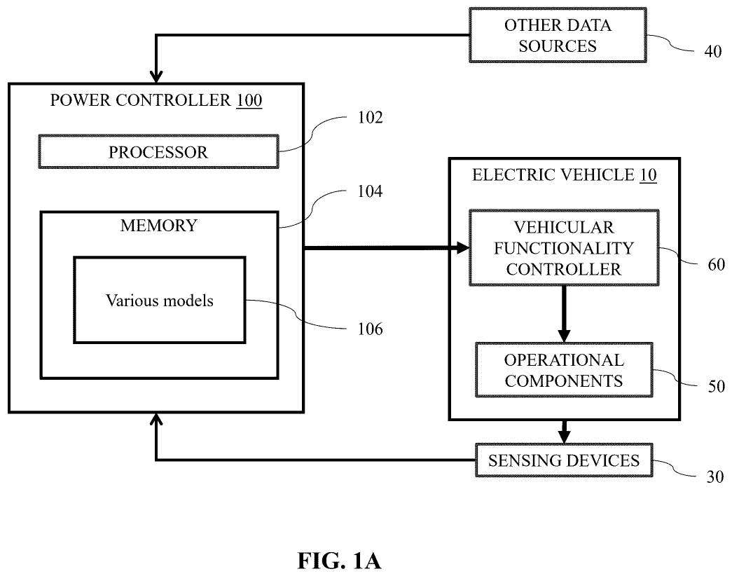

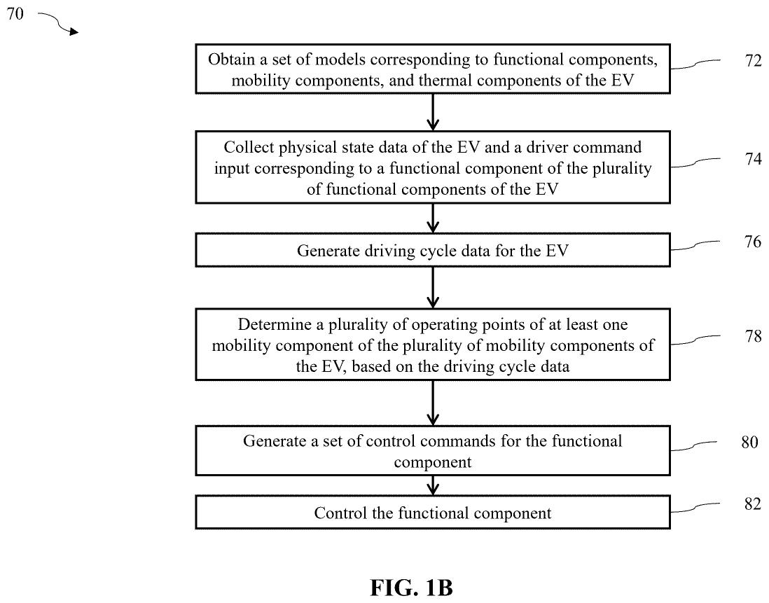

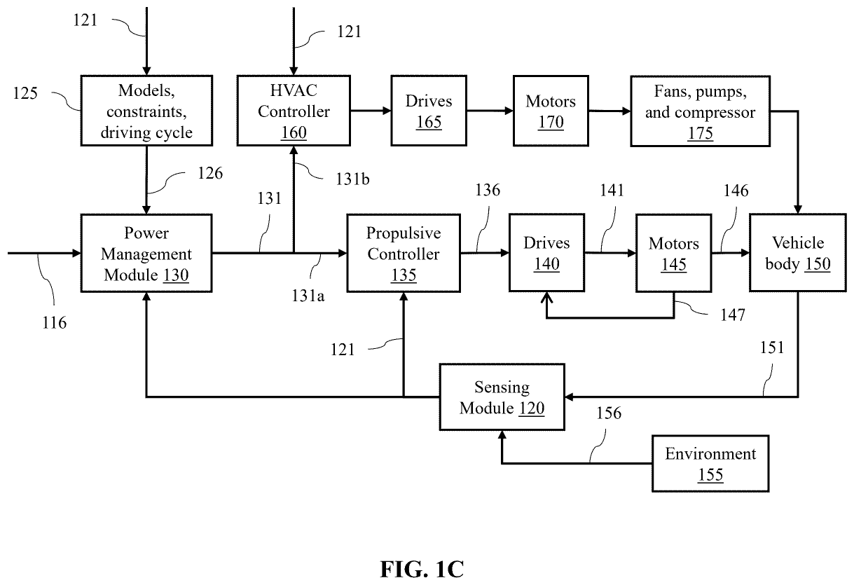

FIG. 1A illustrates a block diagram of a power controller 100 for controlling an EV 10, according to some embodiments of the present disclosure. The power controller (or simply controller) 100 is communicatively coupled to the EV 10. The controller 100 includes a processor 102 and a memory 104. The processor 102 may be a single core processor, a multi-core processor, a computing cluster, or any number of other configurations. The memory 104 may include random access memory (RAM), read only memory (ROM), flash memory, or any other suitable memory systems. Additionally, in some embodiments, the memory 104 may be implemented using a hard drive, an optical drive, a thumb drive, an array of drives, or any combinations thereof.

According to some embodiments, the controller 100 controls one or more operational components 50 of the EV 10 through a corresponding vehicular functionality controller 60. FIG. 1B illustrates a method 70 for controlling the EV 10, according to some embodiments and will be described in conjunction with FIG. 1A. In this regard, the controller 100 may obtain 72 various types of data from the other data sources 40. Such data may include a set of models 106 corresponding to the operational components of the EV. The operational components may include a plurality of functional components of the EV, a plurality of mobility components of the EV, and a plurality of thermal components of the EV. Some examples of the functional components may include an HVAC system of the EV, a wiper control system of the EV, a light control system of the EV, and the like. Some examples of the mobility components of the EV include propulsion motors of the EV. Some examples of the thermal components of the EV include one or more batteries of the EV, the cabin of the EV, an HVAC subsystem of the EV, the propulsion motors of the EV, and the like. The controller 100 may collect 74 sensory data corresponding to the physical state of the vehicle 10 from one or more sensing devices 30. The physical state of the EV may be defined in terms of motion parameters such as but not limited to the acceleration of the EV, distance travelled by the EV, a current location of the EV, thermal parameters such as a temperature of cabin and a temperature of the battery of the EV, electrical parameters such as battery status of the EV expressed in terms of voltage and current, and other physical parameters such as pressure of coolant at the compressor of an HVAC subsystem of the EV and the like.

The controller 100 may generate 76 driving cycle data for the EV, based on the physical state data. According to some embodiments, the driving cycle data for the EV may be generated by a third party system that may be co-located with or remotely located from the controller 100. The controller 100 determines 78 a plurality of operating points of at least one mobility component of the plurality of mobility components of the EV, based on the driving cycle data. Each operating point of the plurality of operating points is parameterized by a desired torque and speed of the EV. Furthermore, the controller 100 generates 80 a set of control commands for the functional component, based on the plurality of operating points, the set of models stored in the memory, and the driver command input. Using the commands, the controller controls 82 the functional component 50.

FIG. 1C illustrates a power control system for controlling a propulsive subsystem and an HVAC subsystem of the EV, according to some embodiments. Driver command 116 is submitted to power management module 130, which, taking into account models, constraints, and driving cycles 125 determines the commands of the propulsive subsystem and the HVAC subsystem. The propulsive subsystem command 131a is fed into propulsive controller which outputs torque command 136 to drives 140 which further generate and supply three-phase voltages to power motors 145. The drives 140 determine the phase voltage 141 for supply to the motors 145 so that the torques 146 of the motors can track the torque command 136 accurately. The motor torques 146 are applied on vehicle body 150 through a mechanical coupling between its shaft and the vehicle body to ensure the vehicle body moves as the driver command 116 specifies. On the other hand, HVAC controller takes the HVAC command 131b and turns it into torque or speed command for drives 165, which supplies certain voltages to motors 170 for HVAC subsystem. According to some embodiments, the motors for the HVAC subsystem move compressor, radiator fan, blower fan for cabin cooling air, and pump for coolant. In some embodiments, the BEV may include only one propulsive motor while in some other embodiments, the BEV may include multiple propulsive motors.

In some embodiments, the driver command 116 specifies a target location of the present trip, the route from the present location to the target location, preferred cabin air temperature, and gas pedal position, wherein the target location is represented by GPS coordinates or street address. According to some embodiments, the route may be provided by certain onboard navigation system and represented by a set of waypoints where each waypoint is parameterized by GPS coordinates. According to various embodiments the driver may be viewed as a velocity tracking controller which outputs torque command to ensure the vehicle maintain certain desired speed, and thus the gas pedal position characterizes the torque requirement from the driver.

In some embodiments, during real-time operation, sensing module 120 exploits an inertial measurement unit (IMU) to measure accelerations of the vehicle, an odometer to measure the distance traveled by the vehicle, a GPS sensor to locate the vehicle position, multiple temperature sensors to measure the cabin air temperature, propulsive motor temperature, coolant temperature, cooling air temperature, and battery temperature, electrical sensors to measure voltages and currents of motors and battery, pressure sensors to measure the pressure of refrigerant at the outlet of the compressor, etc. According to some embodiments, the sensing module 120 may also contain hardware and software to receive/process real-time traffic information from the vehicle's present position to its target location. Sensed signals 121 reflect the real-time location, velocity and acceleration of the vehicle body, temperatures of multiple components and ambient environment, pressure and temperature of refrigerant, speeds, currents and voltages of motors, real-time traffic information along the route from the present location to the target location, etc.

In some embodiments, operation points 131 specify the propulsive command 131a of propulsive subsystem and the HVAC command 131b of the HVAC subsystem. The propulsive command 131a comprises preferred currents of propulsive motors driving the movement of the vehicle body. The HVAC command 131b includes the desired temperature of cabin cooling air, the desired mass flow rate of the coolant, and the desired temperature of the coolant when leaving the HVAC subsystem.

In some embodiments, the propulsive command 131a specifies the preferred or desired torques and speeds of the propulsive motors driving the movement of the vehicle body and the HVAC command 131b specify the speed of fans, pumps and compressors of the HVAC subsystem. According to some embodiments, the desired torques and speed of the propulsive motors as well as the speed of fans, pumps and compressors of the HVAC subsystem may be specified in reference to a driving cycle.

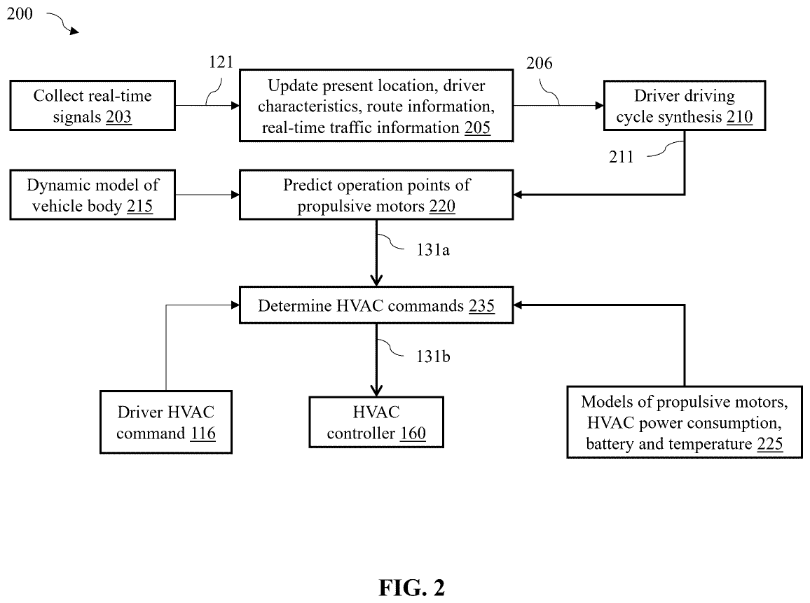

FIG. 2 illustrates a method 200 for generating control commands 131a for the propulsive subsystem and control commands 131b for the HVAC subsystem of the EV, according to some embodiments. The propulsive command 131a and the HVAC command 131b of the propulsive and HVAC sub systems for the BEV may be determined based on real-time measured signals 121. In this regard, the method 200 comprises collecting 203 the real-time measured/sensed signals 121. The route information, real-time traffic information and vehicle present location are updated 205 by processing the sensed signal 121 to produce the route-traffic-specific profile 206, which is used to synthesize 210 a driver-route-traffic-specific driving cycle 211. Using the driver-route-traffic-specific driving cycle 211 and a dynamic model of the vehicle body 215, the method 200 comprises predicting 220 the operation points 131a (or equivalently propulsive commands) of the propulsive motor along the driver-route-specific driving cycle, wherein the operation points 131a are parameterized by the desired torque and speed profiles of propulsive motors along the driving cycle 211. The propulsive operation points 131a, models 225 of propulsive motors, HVAC power consumption, battery, and temperature dynamics, and the driver HVAC command 116 (provided by the driver) are used to determine 235 the HVAC command 131b, which is the reference of HVAC controller 160. The updating, predicting, and determining steps are repeated to update HVAC command 131b once the real-time traffic information is significantly different from the previously predicted profile; or driver HVAC command is changed significantly.

In some embodiments, the route, comprising a sequence of spatial waypoints from the present location to the target location, can be obtained from a standard navigation module, wherein each waypoint is denoted by cartesian coordinates q=(x, y, z). Alternately, according to some embodiments, the route from the present location to the target location may be dynamically generated using map data stored in a database or local cache. Thus, the route information may be represented by N waypoints q₀, . . . , q_{N}, where q₀ denotes the present location and q_{N} denotes the target location.

In some embodiments, the route-traffic-specific information 206 for a particular route (from the present location to the target location) is represented as a velocity/position profile denoted by a dummy variable r(t) for t∈[0, t_{ƒ}] where t_{ƒ} is the final time to accomplish the trip. The t_{ƒ} depends on the real-time traffic information and is updated during real-time. The dummy variable r denotes the longitudinal position or velocity or acceleration along the route.

In some embodiments, the driver-route-traffic-specific driving cycle (or equivalently temporal profile of position or velocity or acceleration of the BEV) defines the estimated position or velocity or acceleration profile, denoted by a dummy variable r*(t) for t∈[0, t_{ƒ}], along the route from the present location to the target location, taking into account the information of the route, real-time traffic, and the driver characteristics.

Some embodiments provide a method to produce the route-traffic-specific profile 206 based on updated vehicle location and real-time traffic information, where the real-time traffic information along the route is represented as spatial velocity v(s(q)) along the route, where s(q) is the distance from the present location to a particular waypoint q of the route. Given the sensed longitudinal velocity and the location at the time step tₖ, denoted by v(tₖ)=vₖ, q(tₖ)=qₖ, the future velocity profile over t∈[tₖ, t_{ƒ}] along the route may be inferred based on the spatial velocity v(s), where tr is the final time to finish the route given the current traffic information, and is to be determined. The temporal velocity v(tₖ+1) at the next time step can be inferred as follows

$$s ( {t}_{k + 1} ) = s ( {t}_{k} ) + {\int }_{{t}_{k}}^{{t}_{k + 1}} v ( t ) dt , v ( {t}_{k + 1} ) ← v ( s ( {t}_{k + 1} ) ) ,$$

where s(tₖ) can be calculated as the distance from q₀ to q(tₖ), s(tₖ₊₁) is the longitudinal distance of the EV at the next time step tₖ₊₁ and v (s(tₖ₊₁)) is the spatial velocity at location s(tₖ₊₁), which is known from the real-time traffic information. The aforementioned process is repeated until the vehicle reaches the target location (i.e., the trip is finished). This process also determines the time t_{ƒ} required to reach the target given the latest real-time spatial traffic information.

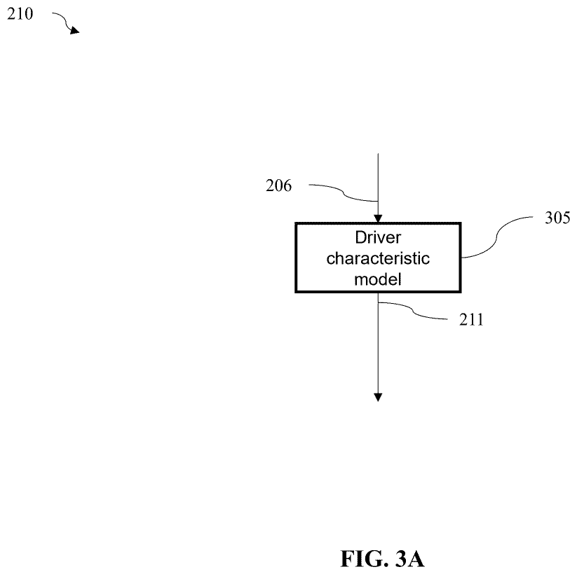

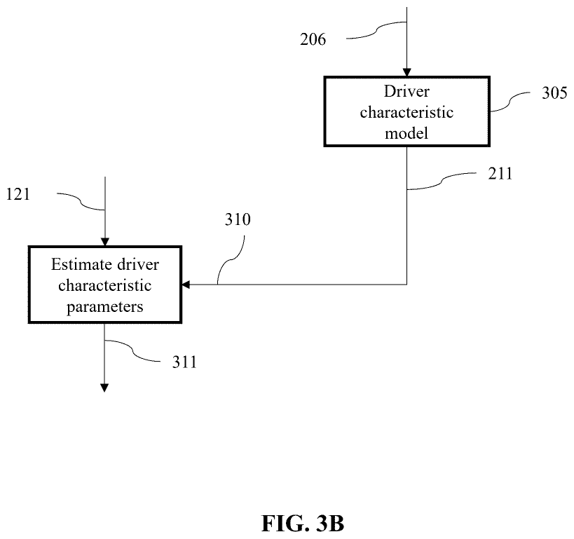

FIG. 3A illustrates an exemplar method for synthesizing 210 driver-route-traffic-specific driving cycle 211, according to some embodiments. The driver-route-traffic-specific cycle 211 may be synthesized by encoding driver characteristics, reflecting, for example, cautious, moderate, and aggressive driving styles. The route-traffic-specific 206 is fed into a driver characteristic model 305 to produce the driver-route-traffic-specific driving cycle 211. The driver characteristics represents how aggressive the driver tries to accelerate and decelerate following the velocity/position profile r(t) in a movable object-following scenario. Hence, the driver characteristics are modeled with the optimal velocity model (OVM) as follows

$$\frac{{ds}^{*}}{dt} = {v}^{*} , \qquad ( 1 )$$

$$\frac{{dv}^{*}}{dt} = α ( {V}_{opt} ( Δ s ( t ) ) - {v}^{*} ( t ) ) ) ,$$

$${V}_{opt} ( Δ s ( t ) ) = {v}_{max} ( tanh ( β ( r ( t ) - {s}^{*} ( t ) ) - γ ) + 1 ) ,$$

where s*(t) and v*(t) are the longitudinal position and driver-specific velocity of the BEV, Vₒₚₜ is a function mapping the relative distance (between a virtual preceding vehicle and the BEV) to velocity, α is the driver sensitivity, β and γ are the slope and the intercept of tanh function, and Δs(t)=r(t)−s*(t) is the relative longitudinal distance to the preceding virtual vehicle where r(t) denotes the position of the preceding virtual vehicle. Each driver might have a different set of values α, β and γ. The driver-route-traffic-specific profile 211 may be denoted as the position or velocity or acceleration temporal profile r*(t) for t∈[0, t_{ƒ}]. It may be noted that the virtual preceding vehicle moves according to the route-traffic-specific profile 206 r(t).

Values of parameters α, β and γ can be estimated on the basis of the driver-route-traffic-specific profile 211 r*(t) and the true profile of the BEV given by s(t), which can be inferred from sensing signals 121 which contains the BEV's location q(t).

FIG. 3B illustrates a method for identifying driver characteristic parameters, according to some embodiments. Given the real-time sensing signal 121, which includes the true profile s(t), it is compared against the driver-route-traffic-specific profile 211 r*(t)=s*(t), which is viewed as the model-based prediction of the s(t), which is viewed as measured variable in standard state and parameter estimate problem. The driver characteristic parameters are estimated by minimizing the least square error between r*(t) and s(t). Various dynamic model-based estimators, such as particle filter, adaptive estimator, and nonlinear least square estimator, can be used to estimate the driver model parameters α, β and γ. The estimated parameters 311 are fed into the driver characteristic model 305 to update the model parameters.

In some embodiment, the driver model parameters α, β and γ are updated recursively, or alternatively updated using the batch data collected along a whole trip, in order to reflect the fact that these parameters are rarely changing over time for a specific driver.

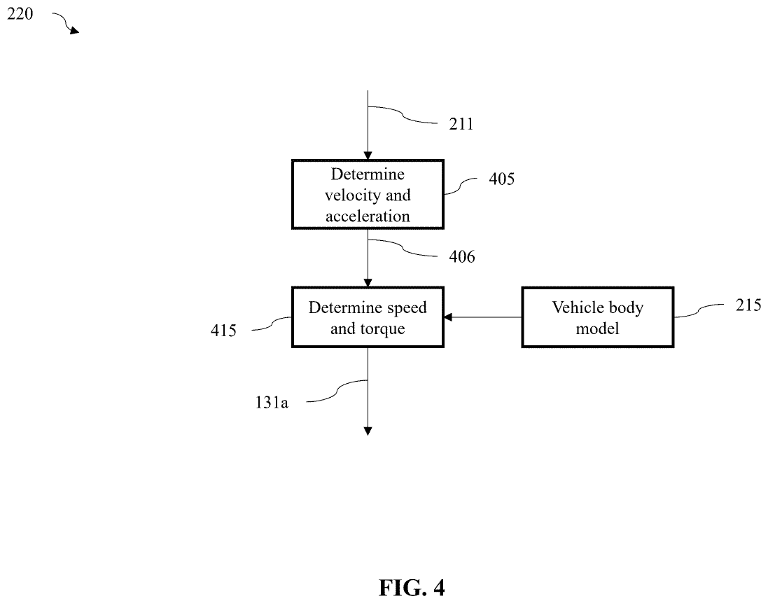

FIG. 4 illustrates a method for generating 220 propulsive command 131a based on the driver-route-traffic-specific profile 211 and a vehicle body model, according to some embodiments. The vehicle body model captures at least the dynamics of the longitudinal movement. In some embodiments, the driver-route-traffic-specific profile r*(t) 211 specifies the temporal profile of the longitudinal distance s*(t), and then the corresponding velocity and acceleration 406 are determined by various established methods where the velocity v*(t) is obtained by taking numerical time derivative of r*(t) and the acceleration a*(t) is obtained by taking numerical second-order time derivative of r*(t). In some embodiments, the driver-route-traffic-specific profile r*(t) 211 specifies the temporal profile of the longitudinal velocity v*(t) and then the acceleration a*(t) is obtained by taking numerical time derivative of v*(t). The signals s*(t), v*(t), a*(t) and the vehicle body model 215 are used to determine 415 the propulsive command which is denoted as a temporal profile (ω*(t), t*(t)), wherein t*(t) represents the torque that the propulsive motors have to deliver to the vehicle body through the rotor shafts.

In some embodiments, the vehicle body model 215 is given by the following equations:

$$m \frac{{dv}^{*}}{dt} = \frac{{τ}^{*}}{{R}_{w}} - \frac{1}{2} ρ {A}_{f} {{C}_{d} ( {v}^{*} )}^{2} + {f}_{r} mg cos θ + mg sin θ \qquad ( 2 )$$

where m, R_{w}, ρ, A_{ƒ}, C_{d}, ƒᵣ, g, and θ are the vehicle mass, wheel radius, air density, vehicle frontal area, air drag coefficient, rolling resistance coefficient, gravitational constant, and road grade, respectively. Given the driver-route-traffic-specific profile v* and the parameter values of the vehicle body model, the net torque to be delivered to the vehicle body may be determined as follows

$${τ}^{*} = {R}_{w} ( m \frac{{dv}^{*}}{dt} + \frac{1}{2} ρ {A}_{f} {{C}_{d} ( {v}^{*} )}^{2} + {f}_{r} mg cos θ + mg sin θ ) .$$

Considering the fact that the motor speed is linearly proportional to v* with a ratio determined by the gearbox, the propulsive command (ω*, t*) is determined from driver-route-traffic-specific profile v* and the vehicle body model (eqn. 2).

In some embodiments, the vehicle body model also considers the dynamics of the vertical displacement (vehicle altitude) to characterize the gravity induced torque that the propulsive motors have to overcome.

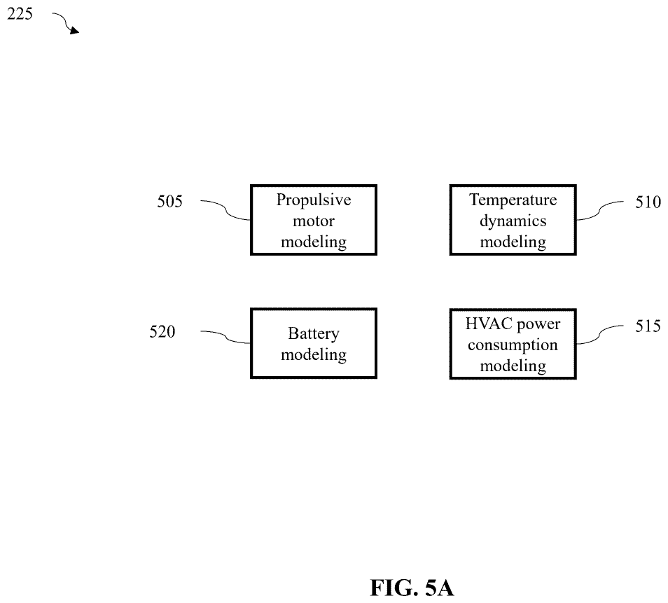

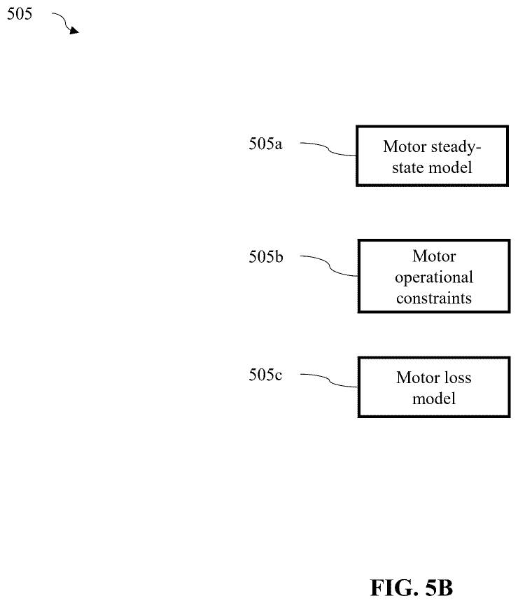

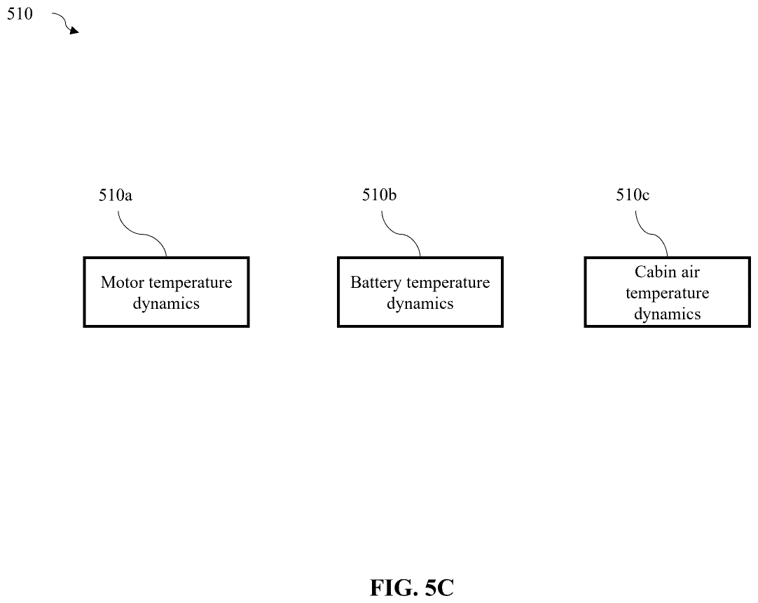

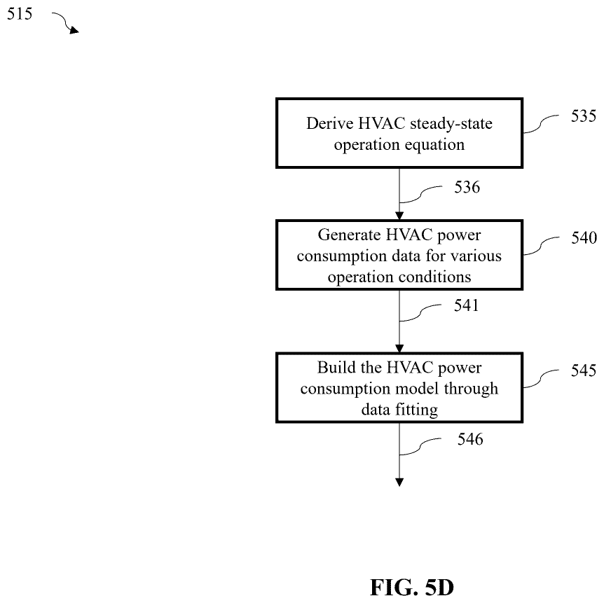

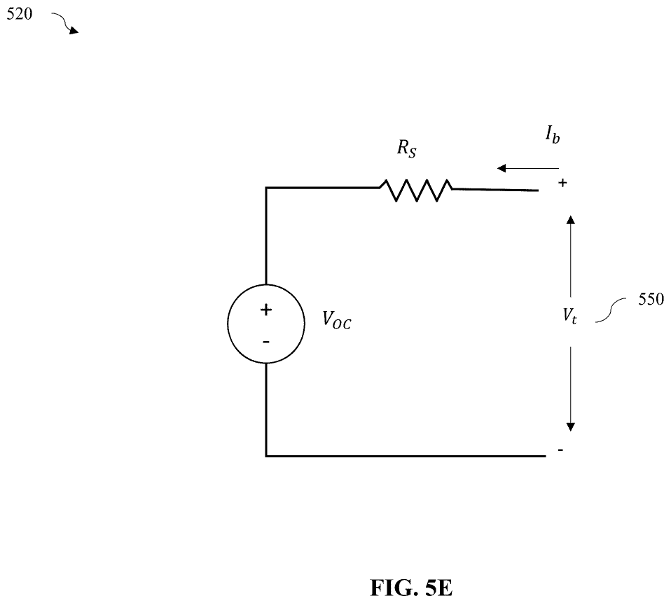

FIG. 5A illustrates the various modelling frameworks utilized for controlling a BEV, according to some embodiments. The various modeling frameworks include propulsive motor modeling 505 of the propulsive motors, temperature dynamics modeling 510 of various thermal components of the BEV, HVAC power consumption modeling 515 of the HVAC subsystem, and battery modeling 520 of the battery of the BEV. FIGS. 5B, 5C, 5D, and 5E illustrate schematics of the propulsive motor modeling 505 for the EV, the temperature dynamics modeling 510 for the EV, the HVAC power consumption modeling 515 for the EV, and the battery modeling 520 for the EV, respectively, according to some embodiments.

Referring to FIG. 5B, the propulsive motor modeling 505 comprises the derivation of a motor steady-state model 505a, a motor operational constraints 505b and a motor loss model 505c. In some embodiments, the propulsive motor is a type of interior permanent magnet motor (IPM). The dynamics of the IPM can be modeled as follows

$${i}_{d} = \frac{1}{{L}_{d}} ( - R {i}_{d} + p ω {L}_{q} {i}_{q} + {u}_{d} ) \qquad ( 3 )$$

$${i}_{q} = \frac{1}{{L}_{q}} ( - R {i}_{q} - ( {L}_{d} {i}_{d} + {Φ}_{m} ) p ω + {u}_{q} )$$

$$J \dot{ω} = \frac{3 p}{2} \{ {Φ}_{m} {i}_{q} + ( {L}_{d} - {L}_{q} ) {i}_{q} {i}_{d} \} - {T}_{L} ,$$

where i_{d} and i_{q} are d-axis current and q-axis current, respectively; ω is the motor angular speed; u_{d}, u_{q} are d- and q-axes voltages supplied by the drives module 140 to the motor, respectively, and T_{L} is the load torque; ϕₘ is the permanent magnet flux, R is the stator winding resistance, L_{d} and L_{q} are the inductances of d- and q-axes, respectively, J is the rotor inertia of the motor, and p is the number of pole pairs of the motor. Note that i_{d}, i_{q} can be controlled by u_{d} and u_{q}, respectively, which is mainly accomplished by the drives module 140; and that the motor speed w is linearly proportional to the vehicle speed v*(t) 131a through the ratio regulated by a gearbox.

In some embodiments, T_{L} contains the sum of the net torque to be delivered to the vehicle body and the torque induced by friction between ball bearing and the rotating shaft of the motor.

The steady-state motor model 505a is obtained by setting the left-hand-side of the first two equations of (3) to zero and solving for motor current reference

$$( {i}_{d}^{*} , {i}_{q}^{*} )$$

for a given operation point 131a given by (ω*, τ*). That is:

$$0 = - R {i}_{d} + p {ω}^{⋆} {L}_{q} {i}_{q} + {u}_{d}$$

$$0 = - R {i}_{q} - ( {L}_{d} {i}_{d} + {Φ}_{m} ) p {ω}^{⋆} + {u}_{q}$$

$${τ}^{*} + J {\dot{ω}}^{*} = \frac{3 p}{2} ( {Φ}_{m} + ( {L}_{d} - {L}_{q} ) {i}_{d} ) {i}_{q} .$$

Since ω* is linearly proportional to v*(t) and thus is treated as known signal, then \dot{ω}* is also a known signal.

The operational constraints 505b specify that the motor voltage cannot exceed a threshold Vₘₐₓ and the motor currents cannot exceed a threshold iₘₐₓ determined by the heat loading of the motor. The operational constraints 505b admit the following form:

$${( {L}_{q} {i}_{q} )}^{2} + {( {Φ}_{m} + {L}_{d} {i}_{d} )}^{2} \leq {( \frac{{V}_{max}}{p ω} )}^{2}$$

$${i}_{d}^{2} + {i}_{q}^{2} \leq {i}_{max}^{2} .$$

The maximum voltage threshold Vₘₐₓ is linearly proportional to DC-bus voltage V_{DC}, which in some embodiments, is approximated as the terminal voltage of the battery pack. The proportional ratio between Vₘₐₓ and V_{DC} depends on the modulation scheme used in the drive units 140. Without loss of generality, and without limitation, some embodiments denote Vₘₐₓ=0.5 V_{DC}.

Some example embodiments may represent the motor loss model 505c as analytical functions of the motor current reference

$$( {i}_{d}^{*} , {i}_{q}^{*} )$$

and operation point (ω*, τ*). The motor losses P_{motor,loss} may be modeled as P_{motor,loss}=P_{copper,loss}+P_{hyst,loss}+P_{eddy,loss}. Specifically, P_{copper,loss}, P_{hyst,loss}, and P_{eddy,loss} denote copper loss, hysteresis loss, and eddy loss, respectively and are given by

$${P}_{copper , loss} = \frac{3}{2} R ( {( {i}_{d}^{*} )}^{2} + {( {i}_{q}^{*} )}^{2} ) \qquad ( 4 )$$

$${P}_{hyst , loss} = {k}_{hyst} Φ \frac{p {ω}^{*}}{2 π}$$

$${P}_{eddy , loss} = {k}_{eddy} Φ {( \frac{p {ω}^{*}}{2 π} )}^{2}$$

$$Φ = \sqrt{{( {L}_{q} {i}_{q}^{*} )}^{2} + {( {Φ}_{m} + {L}_{d} {i}_{d}^{*} )}^{2}} ,$$

where k_{hyst} and k_{eddy} are hysteresis loss coefficient and eddy loss coefficient, respectively; and ¢ is the motor magnetic flux. As such, the motor loss models 505c are analytical functions of motor current reference i*_{d} and i*_{q} and the operation point (ω*, τ*). The motor power Pₘₒₜₒᵣ at the given operation point (ω*, τ*) is calculated as Pₘₒₜₒᵣ=τ*ω*+P_{motor,loss}.

FIG. 5C illustrates the temperature dynamics to be considered in order to derive the HVAC power consumption model and determine HVAC command. Specifically, the dynamics of motor temperature 510a, battery temperature 510b, and cabin air temperature 510c are modeled as ordinary differential equations as follow:

$${M}_{b} {c}_{b} {\dot{T}}_{b} = - {α}_{b} ( {T}_{b} - {T}_{a m b} ) + {Q}_{b} + {\dot{m}}_{c l n t} {c}_{c l n t} ( {T}_{c l n t} - {\overline{T}}_{c l n t} ) \qquad ( 5 )$$

$${M}_{m} {c}_{m} {\dot{T}}_{m} = - {α}_{m} ( {T}_{m} - {T}_{a m b} ) + {Q}_{m} + {\dot{m}}_{c l n t} {c}_{c l n t} ( {\overline{T}}_{c l n t} - {\check{T}}_{c l n t} )$$

$${M}_{cab} {c}_{cab} {\dot{T}}_{cab} = - {α}_{c a b} ( {T}_{c a b} - {T}_{a m b} ) + {\dot{m}}_{air} {c}_{air} ( {T}_{a i r} - {T}_{c a b} ) + {Q}_{r a d} + {Q}_{psgr} ,$$

where T_{b}, Tₘ, T_{cab}, T_{amb}, Tₐᵢᵣ, T_{clnt} are the temperatures of battery, motor, cabin air, ambient, cooling air to the cabin, and coolant, respectively; T̅_{clnt}, T̆_{clnt} are the temperatures of coolant after exits of battery and motor, respectively; \dot{m}ₐᵢᵣ, \dot{m}_{clnt} are the mass flow rates of cabin cooling air and coolant, respectively; M_{b}, Mₘ, M_{cab} are the masses of battery, motor and cabin air, respectively; c_{b}, cₘ, c_{cab}, cₐᵢᵣ, c_{clnt} are the specific heat of the battery, motor, cabin air, cooling air, and coolant, respectively; Q_{rad}, Q_{psgr}, Q_{b}, Qₘ are heat generated by solar radiation, passenger, battery losses, and motor losses, respectively; α_{b}, αₘ, α_{cab} are the heat transfer coefficients;

$${\overline{T}}_{c l n t} = {T}_{b} + ( {T}_{c l n t} - {T}_{b} ) exp ( - {K}_{b} / ( {\dot{m}}_{clnt} {c}_{clnt} ) ) \qquad ( 6 )$$

$${\check{T}}_{c l n t} = {T}_{m} + ( {\overline{T}}_{c l n t} - {T}_{m} ) exp ( - {K}_{m} / ( {\dot{m}}_{c l n t} {c}_{clnt} ) ) ,$$

where K_{b} and Kₘ are the heat exchange coefficients.

In some embodiments, T̆_{clnt} represents the temperature of coolant at the location where the coolant flows back to (enters) the HVAC subsystem. The dynamic models 510 of temperatures are given by (5), wherein the state variables are temperatures of battery, motor, and cabin air, and the control variables are the cooling air temperature Tₐᵢᵣ, cooling air mass flow rate mₐᵢᵣ, coolant mass flow rate \dot{m}_{clnt} and coolant temperature T_{clnt} before entering the battery.

In some embodiments, the cabin cooling air mass flow rate is assumed to be fixed, and thus the temperature dynamic models have three control variables: the cooling air temperature Tₐᵢᵣ, coolant mass flow rate \dot{m}_{clnt} and coolant temperature T_{clnt}.

FIG. 5D discloses schematics for deriving the HVAC power consumption model 515. At first, a set of nonlinear algebraic equations representing the HVAC subsystem steady-state operation are derived 535 from well-established dynamic models of HVAC subsystem by setting all time derivatives to zero. The HVAC steady-state operation model 536 characterizes the analytical relationship between the HVAC subsystem state variables, control variables, and external boundary conditions. Specifically, the HVAC state variables contain coolant temperature, cooling air temperature, refrigerant temperature/pressure; the HVAC control variables contain speeds of compressor, cooling air blower fan, radiator fan, and coolant pump; and the HVAC boundary conditions contain the vehicle speed, the temperatures of battery, cabin air, motor, ambient, mass flow rates of cooling air and coolant, and cooling air/coolant leaving and returning to the HVAC subsystem; and the relationship between the power consumption of compressor, fans, and pumps given their rotating speeds. Given the nonlinear algebraic equations 536, one can compute 540 the minimum HVAC power consumption value 541 P_{HVAC} at each feasible operation condition (characterized by boundary conditions variables T_{cab}, Tₘ, T_{b}, T_{amb}, Tₐᵢᵣ, T_{clnt}, \dot{m}_{clnt}, v) by solving an optimization problem which determines the energy-optimal HVAC control variables such as the speeds of compressor, cooling air blower fan, radiator fan, and coolant pump for given values of control variables of temperature models and boundary conditions of HVAC subsystem for best energy efficiency. The generated HVAC power consumption data are used to build the HVAC power consumption model through data fitting 545.

In some embodiments, the HVAC power consumption model is defined as an analytical function of cabin air temperature T_{cab}, motor temperature Tₘ, battery temperature T_{b}, ambient temperature T_{amb}, cabin cooling air temperature Tₐᵢᵣ, coolant temperature T_{clnt}, coolant mass flow rate \dot{m}_{clnt}, and the vehicle velocity v*(t). That is: the HVAC power consumption model admits the following form:

$${P}_{HVAC} = {f}_{HVAC} ( {T}_{cab} , {T}_{m} , {T}_{b} , {T}_{a m b} , {T}_{a i r} , {T}_{c l n t} , {\dot{m}}_{c l n t} , v ) .$$

The aforementioned model is based on the simplification that the cabin cooling air mass flow rate is fixed.

In some embodiments, the HVAC power consumption data 541 may be used to train a neural network which approximates the function ƒ_{HVAC}(⋅), wherein the training is carried out via supervised learning so that the neural network tries to predict the HVAC power consumption close to the power consumption value in 541 in the root mean square error sense.

In some embodiments, the HVAC power consumption model admits the following form:

$${P}_{HVAC} = {f}_{HVAC} ( {T}_{c a b} , {T}_{m} , {T}_{b} , {T}_{a m b} , {T}_{a i r} , {T}_{c l n t} , {\dot{m}}_{clnt} , {\dot{m}}_{a i r} , v ) ,$$

which includes the mass flow rate of cooling air as a control variable of the cabin air temperature dynamics. The corresponding power consumption model can be obtained by following the method taught in this invention.

In some embodiments, battery modeling 520 employs a well-established equivalent electric circuit model 550 for a battery cell, as illustrated in FIG. 5E, to model the evolution of state-of-charge (SOC) and the terminal voltage of the battery cell over time, where V_{oc}, Rₛ, Vₜ, I_{b} are the open-circuit voltage (OCV), internal resistance, terminal voltage, and charge/discharge current of the battery cell. Specifically V_{oc} is a nonlinear function of the SOC of the battery cell where the SOC is related to the discharge current Ip. A simple battery cell model is given by

$$\frac{d S O C}{dt} = - \frac{{I}_{b}}{Q} \qquad ( 7 )$$

$${V}_{t} = {V}_{o c} ( SOC ) - {I}_{b} {R}_{s} ,$$

where Q is the capacity of the battery cell and I_{b}>0 means discharging. In some embodiments, ns battery cells are connected in series to form a series-connected branch so that the DC bus voltage is elevated, and nₚ series-connected branches are connected in parallel to increase the max DC bus current. Assume all battery cells have the same electrical and thermal properties such as SOC-OCV function V_{oc}(SOC), model parameters such as resistance and capacity, and the max current I_{b,max}, thus the DC bus voltage is given by V_{DC}=ns (V_{oc}−I_{b}Rₛ) and the max DC bus current is nₚI_{b,max}. Given the SOC and the battery cell current I_{b}, one can calculate the battery cell loss (as a heat source in the battery temperature dynamics) as

$${P}_{bc , loss} = {I}_{b}^{2} {R}_{s}$$

and the battery cell discharging power is

$${P}_{b c} = {I}_{b} {V}_{o c} ( SOC ) .$$

As a result, the total power and losses of the battery pack are:

$${P}_{bp} = {n}_{s} {n}_{p} {P}_{b c} , {P}_{bp , loss} = {n}_{s} {n}_{p} {P}_{bc , loss} .$$

The total power of battery pack will be used to determine the HVAC command, and the losses of the battery pack will enter the battery temperature dynamics as a heat source.

The HVAC subsystem's objective is to regulate the cabin temperature, motor temperature and battery temperature within pre-defined ranges while minimizing the battery energy consumption consisting of propulsive motor power, HVAC subsystem power, and battery losses.

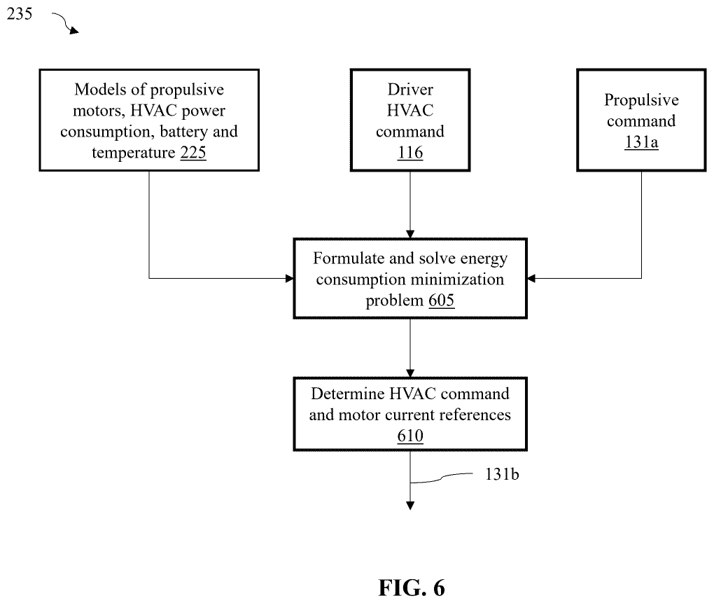

FIG. 6 illustrates a method for determining 235 the HVAC command 131b, according to some embodiments. Based on models 225, driver HVAC command 116 and propulsive command 131a, an energy consumption minimization problem is formulated 605. Some embodiments consider the case where the BEV is equipped with one propulsive motor. The corresponding energy consumption minimization problem for a given driver-route-traffic-specific driving cycle r*(t) over time t∈[0, t_{ƒ}] is formulated as follows:

$${min}_{{u}_{m} , {u}_{HVAC}} {\int }_{0}^{{t}_{f}} {P}_{bp} ( x , {u}_{m} , {u}_{HVAC} ) dt , \qquad ( 8 )$$

$$subject to \qquad \dot{x} = {f}_{dyn} ( x , {u}_{m} , {u}_{HVAC} , {T}_{a m b} , {Q}_{rad} , {Q}_{p s g r} ) ,$$

$${τ}^{*} + J {\dot{ω}}^{*} = \frac{3 p}{2} ( {Φ}_{m} + ( {L}_{d} - {L}_{q} ) {i}_{d} ) {i}_{q} ,$$

$${( {L}_{q} {i}_{q} )}^{2} + {( {Φ}_{m} + {L}_{d} {i}_{d} )}^{2} \leq {( \frac{{V}_{max}}{p {ω}^{⋆}} )}^{2} ,$$

$${i}_{d}^{2} + {i}_{q}^{2} \leq {i}_{max}^{2}$$

$${T}_{b , min} \leq {T}_{b} \leq {T}_{b , max} ,$$

$${T}_{m , min} \leq {T}_{m} \leq {T}_{m , max} ,$$

$${T}_{cab , min} \leq {T}_{c a b} \leq {T}_{cab , max} ,$$

$${T}_{air , min} \leq {T}_{a i r} \leq {T}_{air , max} ,$$

$${T}_{clnt , min} \leq {T}_{clnt} \leq {T}_{clnt , max} ,$$

$${\dot{m}}_{clnt , min} \leq {\dot{m}}_{clnt} \leq {\dot{m}}_{clnt , max} ,$$

$${V}_{max} = 0.5 {n}_{s} ( {V}_{o c} ( SOC ) + {I}_{b} {R}_{s} ) ,$$

$${n}_{p} {n}_{S} {V}_{t} {I}_{b} = ( {P}_{m o t o r} + {P}_{HVAC} ) ,$$

$$0 \leq {I}_{b} \leq {I}_{b , max} ,$$

where x=(T_{b}, Tₘ, T_{cab}, SOC) T is the system state, uₘ(t)=(i_{d}, i_{q})^{T} denotes motor currents to meet the propulsive demand, ƒ_{dyn}(⋅) denotes the dynamic model of SoC and temperatures of battery, motor and cabin air, u_{HVAC}=(Tₐᵢᵣ, T_{clnt}, \dot{m}_{clnt}) T is the HVAC command, and ω*=Zv* with Z being the ratio governed by the gearbox ratio. T_{cab,min}, T_{cab,max} denote minimum and maximum temperatures of cabin air, respectively; T_{b,min}, T_{b,max} denote the minimum and maximum temperatures of battery, respectively; T_{m,min}, T_{m,max} denote the minimum and maximum temperatures of the propulsive motor, respectively; T_{air,min}, T_{air,max} denote the minimum and maximum temperatures of cabin cooling air, respectively; T_{clnt,min}, and T_{clnt,max} denote minimum and maximum temperatures of coolant, respectively; and \dot{m}_{clnt,min}, and \dot{m}_{clnt,max} denote minimum and maximum mass flow rates of coolant, respectively. All models and constraints in the energy consumption minimization problem (8) are analytical and thus the optimization problem can be readily implemented and solved. The optimal solution may be represented as a temporal profile of HVAC command u*_{HVAC}(t) over time horizon t∈[0, t_{ƒ}]. During real-time operation, u*_{HVAC}(t) at the current time step may be solved to determine 610 and output the HVAC command 131b. The battery power admits another formula: P_{bp}(x, uₘ, u_{HVAC})=Pₘₒₜₒᵣ+P_{HVAC}+P_{bp,loss}. According to some embodiments, at 610, the HVAC command 131b may be provided along with the motor current references.

In some embodiments, the energy consumption minimization problem is solved once the driver-route-traffic-specific profile is updated and the u*_{HVAC}(t) at the current time step is outputted as HVAC command 131b.

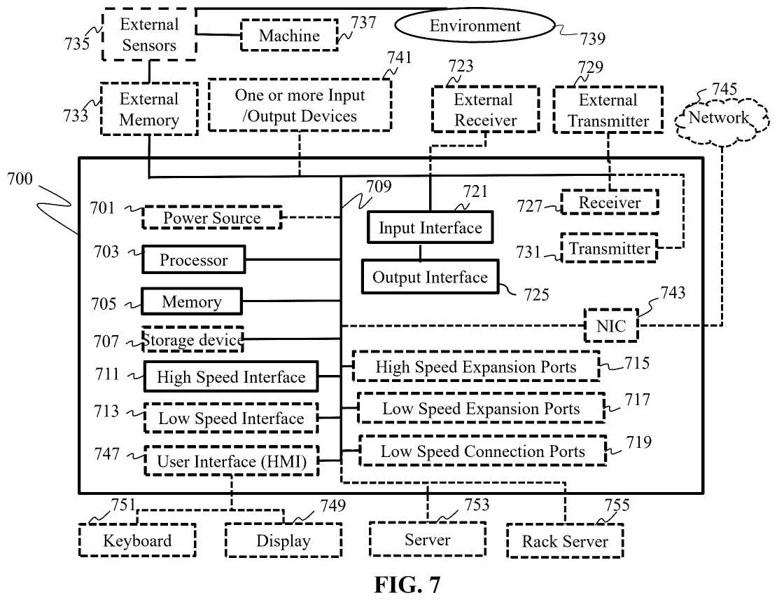

FIG. 7 is a schematic illustrating a computing device 700 for implementing the controller 100 and methods of the present disclosure. The computing device 700 includes a power source 701, a processor 703, a memory 705, a storage device 707, all connected to a bus 709. Further, a high-speed interface 711, a low-speed interface 713, high-speed expansion ports 715 and low speed connection ports 717, can be connected to the bus 709. In addition, a low-speed expansion port 719 is in connection with the bus 709. Further, an input interface 721 can be connected via the bus 709 to an external receiver 723 and an output interface 725. A receiver 727 can be connected to an external transmitter 729 and a transmitter 731 via the bus 709. Also connected to the bus 709 can be an external memory 733, external sensors 735, machine(s) 737, and an environment 739. Further, one or more external input/output devices 741 can be connected to the bus 709. A network interface controller (NIC) 743 can be adapted to connect through the bus 709 to a network 745, wherein data or other data, among other things, can be rendered on a third-party display device, third party imaging device, and/or third-party printing device outside of the computer device 700.

The memory 705 can store instructions that are executable by the computer device 700 and any data that can be utilized by the methods and systems of the present disclosure. The memory 705 can include random access memory (RAM), read only memory (ROM), flash memory, or any other suitable memory systems. The memory 705 can be a volatile memory unit or units, and/or a non-volatile memory unit or units. The memory 705 may also be another form of computer-readable medium, such as a magnetic or optical disk.

The storage device 707 can be adapted to store supplementary data and/or software modules used by the computer device 700. The storage device 707 can include a hard drive, an optical drive, a thumb-drive, an array of drives, or any combinations thereof. Further, the storage device 707 can contain a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, the processor 703), perform one or more methods, such as those described above.

The computing device 700 can be linked through the bus 709, optionally, to a display interface or user Interface (HMI) 747 adapted to connect the computing device 700 to a display device 749 and a keyboard 751, wherein the display device 749 can include a computer monitor, camera, television, projector, or mobile device, among others. In some implementations, the computer device 700 may include a printer interface to connect to a printing device, wherein the printing device can include a liquid inkjet printer, solid ink printer, large-scale commercial printer, thermal printer, UV printer, or dye-sublimation printer, among others.

The high-speed interface 711 manages bandwidth-intensive operations for the computing device 700, while the low-speed interface 713 manages lower bandwidth-intensive operations. Such an allocation of functions is an example only. In some implementations, the high-speed interface 711 can be coupled to the memory 705, the user interface (HMI) 747, and to the keyboard 751 and the display 749 (e.g., through a graphics processor or accelerator), and to the high-speed expansion ports 715, which may accept various expansion cards via the bus 709. In an implementation, the low-speed interface 713 is coupled to the storage device 707 and the low-speed expansion ports 717, via the bus 709. The low-speed expansion ports 717, which may include various communication ports (e.g., USB, Bluetooth, Ethernet, wireless Ethernet) may be coupled to the one or more input/output devices 741. The computing device 700 may be connected to a server 753 and a rack server 755. The computing device 700 may be implemented in several different forms. For example, the computing device 700 may be implemented as part of the rack server 755.

The above description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements. Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks. Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Further, use of ordinal terms such as “first,” “second,” in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Although the present disclosure has been described with reference to certain preferred embodiments, it is to be understood that various other adaptations and modifications can be made within the spirit and scope of the present disclosure. Therefore, it is the aspect of the appended claims to cover all such variations and modifications as come within the true spirit and scope of the present disclosure.

What is claimed is:

1. A controller for controlling an electric vehicle (EV), comprising:
a memory configured to store computer-executable instructions and a set of models corresponding to a plurality of functional components of the EV, a plurality of mobility components of the EV, and a plurality of thermal components of the EV; and
a processor configured to execute the instructions to:
collect physical state data of the EV and a driver command input corresponding to a functional component of the plurality of functional components of the EV;
generate driving cycle data for the EV, based on the physical state data;
determine a plurality of operating points of at least one mobility component of the plurality of mobility components of the EV, based on the driving cycle data, wherein each operating point of the plurality of operating points is parameterized by a desired torque and speed of the EV;
generate a set of control commands for the functional component, based on the plurality of operating points, the set of models stored in the memory, and the driver command input; and
control the functional component, based on the set of control commands.

2. The controller of claim 1, wherein the functional component comprise a Heating Ventillation and Air Conditioning (HVAC) subsystem of the EV, wherein the plurality of mobility components comprise one or more propulsion systems of the EV, and wherein the plurality of thermal components comprise heat sources in the EV.

3. The controller of claim 2, wherein the set of control commands define one or more temperature setpoints for a cabin of the EV, a cooling air temperature entering the cabin of the EV, one or more mass flow rates of coolant in the HVAC system, and a temperature of the coolant when exiting a compressor of the HVAC subsystem.

4. The controller of claim 2, wherein the physical state data comprises acceleration data of the EV, travelled distance data of the EV, location data of the EV, temperature data of the EV, battery status data of the EV, and pressure data of the HVAC system.

5. The controller of claim 4, wherein to generate the driving cycle data, the processor is configured to:
derive route information for the EV, real-time traffic information for the EV, and a current location of the EV, based on the physical state data;
generate a route-traffic specific profile of the EV, based on the route information, the real-time traffic information, and the current location of the EV; and
generate a driver-route-traffic-specific driving cycle using the route-traffic specific profile of the EV and a dynamic model representing driver characteristics.

6. The controller of claim 5, wherein to determine the plurality of operating points of the at least one mobility component, the processor is configured to:
obtain a body model of the EV; and
determine the plurality of operating points as mobility commands for the at least one mobility component, based on the body model of the EV and the driver-route-traffic-specific driving cycle.

7. The controller of claim 6, wherein the processor is further configured to control the at least one mobility component in accordance with the mobility commands, wherein the mobility commands specify the preferred torques and speeds of the at least one mobility component.

8. A computer-implemented method for controlling an electric vehicle (EV), comprising:
obtaining a set of models corresponding to a plurality of functional components of the EV, a plurality of mobility components of the EV, and a plurality of thermal components of the EV;
collecting physical state data of the EV and a driver command input corresponding to a functional component of the plurality of functional components of the EV;
generating driving cycle data for the EV, based on the physical state data;
determining a plurality of operating points of at least one mobility component of the plurality of mobility components of the EV, based on the driving cycle data, wherein each operating point of the plurality of operating points is parameterized by a desired torque and speed of the EV;
generating a set of control commands for the functional component, based on the plurality of operating points, the set of models stored in the memory, and the driver command input; and
controlling the functional component, based on the set of control commands.

9. The method of claim 8, wherein the functional component comprise a Heating Ventillation and Air Conditioning (HVAC) system of the EV, wherein the plurality of mobility components comprise one or more propulsion systems of the EV, and wherein the plurality of thermal components comprise heat sources in the EV.

10. The method of claim 9, wherein the set of control commands define one or more temperature setpoints for a cabin of the EV, one or more mass flow rates of coolant in the HVAC system, and a temperature of the coolant when exiting a compressor of the HVAC system.

11. The method of claim 9, wherein the physical state data comprises acceleration data of the EV, travelled distance data of the EV, location data of the EV, temperature data of the EV, battery status data of the EV, and pressure data of the HVAC system.

12. The method of claim 11, wherein generating the driving cycle data further comprises:
deriving route information for the EV, real-time traffic information for the EV, and a current location of the EV, based on the physical state data;
generating a route-traffic specific profile of the EV, based on the route information, the real-time traffic information, and the current location of the EV; and
generating a driver-route-traffic-specific driving cycle using the route-traffic specific profile of the EV.

13. The method of claim 12, wherein determining the plurality of operating points of the at least one mobility component further comprises:
obtaining a body model of the EV; and
determining the plurality of operating points as mobility commands for the at least one mobility component, based on the body model of the EV and the driver-route-traffic-specific driving cycle.

14. The method of claim 13, further comprising controlling the at least one mobility component in accordance with the mobility commands, wherein the mobility commands specify the preferred torques and speeds of the at least one mobility component.

15. A non-transitory computer readable medium having stored thereon instructions that when executed by a computer, cause the computer to perform a method for controlling an electric vehicle (EV), the method comprising:
obtaining a set of models corresponding to a plurality of functional components of the EV, a plurality of mobility components of the EV, and a plurality of thermal components of the EV;
collecting physical state data of the EV and a driver command input corresponding to a functional component of the plurality of functional components of the EV;
generating driving cycle data for the EV, based on the physical state data;
determining a plurality of operating points of at least one mobility component of the plurality of mobility components of the EV, based on the driving cycle data, wherein each operating point of the plurality of operating points is parameterized by a desired torque and speed of the EV;
generating a set of control commands for the functional component, based on the plurality of operating points, the set of models stored in the memory, and the driver command input; and
controlling the functional component, based on the set of control commands.
